(19) United States
(12) Patent Application Publication
(10) Pub. No.: US 2013/0140921 A1
(43) Pub. Date: Jun. 6, 2013

(54) SPINDLE MOTOR

(71) Applicant: SAMSUNG ELECTRO-MECHANICS CO., LTD., Suwon (KR)

(72) Inventor: Sang Won KIM, Suwon (KR)

(73) Assignee: SAMSUNG ELECTRO-MECHANICS CO., LTD., Suwon (KR)

(21) Appl. No.: 13/687,377

(22) Filed: Nov. 28, 2012

(30) Foreign Application Priority Data
Dec. 1, 2011 (KR) 10-2011-0127480

(51) Int. Cl. H02K 5/24

(52) U.S. Cl. CPC H02K 5/24
USPC 310/51

(57) ABSTRACT

There is provided a spindle motor including a rotor hub having a driving magnet mounted on an internal surface thereof; and a pulling plate fixedly installed on a base member to be disposed below the driving magnet, wherein the pulling plate includes a body having a ring shape, protrusion portions protruded from the body, and an indent portion formed inwardly from an outer circumferential surface of the body.

### CROSS-REFERENCE TO RELATED APPLICATIONS

This application claims the priority of Korean Patent Application No. 10-2011-0127480 filed on Dec. 1, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

Recently, with regard to a spindle motor for a hard disk drive (HDD) mounted in a personal computer (PC) or in peripheral devices thereof, the need for the high-speed reading of data from, and the high-speed writing of data to, a disk mounted thereon have increased, and also, the need for low levels of oscillation, noise, and power consumption have increased along with the need for an increase in recording density.

In addition, requirements to reduce the influence of cogging torque from which oscillation, noise, and power consumption increase during an operation of a spindle motor, to prevent an overcurrent state, and to reduce power consumption have increased.

Simultaneously, the prevention of unnecessary oscillations in a rotor thrust direction has been urgently required.

To this end, a pulling plate is installed on a base member. That is, the pulling plate is installed on the base member to be disposed below a driving magnet.

However, the pulling plate installed on the base member maybe separated from the base member after an external impact. Thus, there is a need to develop a structure for increasing the degree of adhesion between the pulling plate and the base member.

In addition, if the pulling plate and the base member are installed such that the positions of a center of the pulling plate and a center of a magnet correspond to each other, oscillations may be further prevented.

Thus, there is also a need to develop a structure for installing the pulling plate on the base member while allowing the center of the pulling plate and the center of the magnet to coincide with each other.

### SUMMARY OF THE INVENTION

An aspect of the present invention provides a spindle motor for increasing the degree of adhesion of a pulling plate, and simultaneously, for matching positions of centers of the pulling plate and a magnet during installation of the pulling plate, that is, for preventing deviation of the pulling plate.

According to an aspect of the present invention, there is provided a spindle motor, including: a rotor hub having a driving magnet mounted on an internal surface thereof; and a pulling plate fixedly installed on a base member to be disposed below the driving magnet, wherein the pulling plate includes a body having a ring shape, protrusion portions protruded from the body, and an indent portion formed inwardly from an outer circumferential surface of the body.

The pulling plate may be inserted into an installation groove formed downwardly from an upper surface of the base member, and the protrusion portions having a circular hemispherical shape may contact a side wall of the installation groove formed in the base member.

The protrusion portions may include at least three or more protrusion portions to prevent a position of a center of the body from deviating from a position of a center of the driving magnet during installation.

The indent portion may include a plurality of indent portions arranged in a circumferential direction between the protrusion portions.

The pulling plate may be fixedly installed on the base member using an adhesive, and the adhesive may be provided in the indent portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is a perspective view of a pulling plate included in a spindle motor according to an embodiment of the present invention; and

FIGS. 3 and 4 are views for explaining an installation state of a base member and a pulling plate included in a spindle motor according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements .

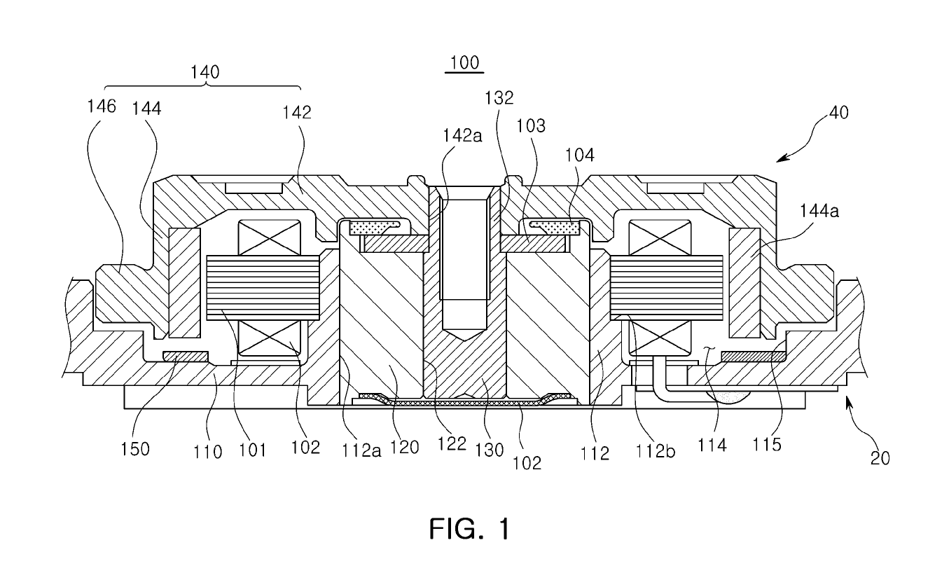

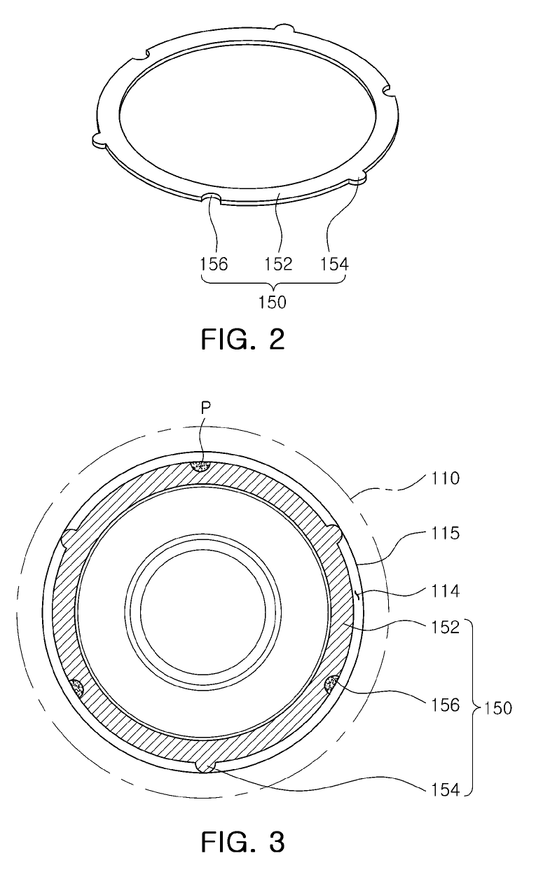

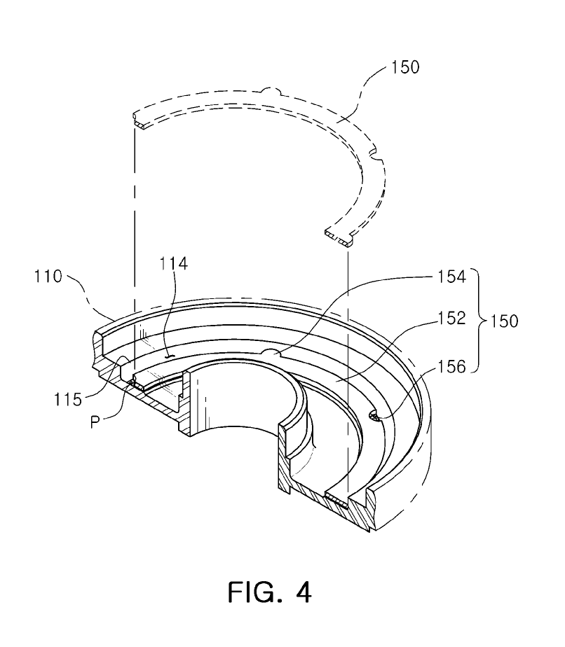

FIG. 1 is a schematic cross-sectional view of a spindle motor according to an embodiment of the present invention. FIG. 2 is a perspective view of a pulling plate included in a spindle motor according to an embodiment of the present invention. FIGS. 3 and 4 are views for explaining an installation state of a base member and a pulling plate included in a spindle motor according to an embodiment of the present invention.

Referring to FIGS. 1 through 4, for example, a spindle motor 100 according to an embodiment of the present invention may include a base member 110, a sleeve 120, a shaft 130, a rotor hub 140, and a pulling plate 150.

The spindle motor 100 according to the present embodiment may be a motor used in a recording disk driving device for rotating a recording disk.

Here, terms with respect to directions will be defined. As viewed in FIG. 1, an axial direction refers to a vertical direction based on the shaft 130, that is, a direction from an upper portion of the shaft 130 to a lower portion thereof or a direction from the lower portion of the shaft 130 to the upper portion thereof, and a radial direction refers to a horizontal direction, that is, a direction toward the shaft 130 from an outer circumferential surface of the rotor hub 140 or a direction toward the outer circumferential surface of the rotor hub 140 from the shaft 130.

In addition, a circumferential direction refers to a direction of rotation along outer circumferential surfaces of the rotor hub 140 and the shaft 130.

The spindle motor 100 according to the present embodiment may largely include a stator 20 and a rotor 40. The stator 20 refers to all fixed members for rotatably supporting the rotor 40. The rotor 40 refers to all rotating members rotatably supported by the stator 20.

The base member 110 is a fixed member constituting the stator 20 rotatably supporting the rotor 40. In addition, the base member 110 may include an installation portion 112 in which the sleeve 120 is fixedly installed.

The installation portion 112 protrudes in the axial direction toward an upper portion of the shaft 130. An installation hole 112a may be formed in the installation portion 112 such that the sleeve 120 may be installed in the installation portion 112 by being inserted into the installation hole 112a.

That is, the sleeve 120 may be fixedly installed in the installation portion 112.

A step portion 112b may be provided on an outer circumferential surface of the installation portion 112, such that a stator core 101 may be insertedly fixed to the outer circumferential surface of the installation portion 112. That is, the stator core 101 may be fixedly installed on the installation portion 112 while being seated on the step portion 112b formed on the outer circumferential surface of the installation portion 112.

In addition, an installation groove 114 may be formed in the base member 110. The installation groove 114 may be formed downwardly from an upper surface of the base member 110.

The pulling plate 150 may be inserted into the installation groove 114 and may be fixedly installed on the base member 110. In addition, the pulling plate 150 may be installed such that an outer circumferential surface of the pulling plate 150 may contact a side wall 115 of the installation groove 114 formed in the base member 110.

This will be described below in more detail.

The sleeve 120 together with the base member 110 constitutes the stator 20. The sleeve 120 is a fixed member for rotatably supporting the rotor 40.

In addition, as described above, the sleeve 120 may be fixedly installed in the installation portion 112. That is, a shaft hole 122 may be formed in a central portion of the sleeve 120. Thus, the shaft 130 may be inserted into the shaft hole 122 so as to be rotatably supported by the sleeve 120.

A cover member 102 for preventing lubricating fluid from leaking may be installed on a lower surface of the sleeve 120.

The shaft 130 is a rotation member constituting the rotor 40 rotating while being rotatably supported by the stator 20.

As described above, the shaft 130 is rotatably supported by the sleeve 120. That is, the shaft 130 is inserted into the shaft hole 122 of the sleeve 120. In this case, an outer circumferential surface of the shaft 130 and an inner circumferential surface of the sleeve 120 are spaced apart from each other by a predetermined interval to form a bearing clearance.

In addition, the bearing clearance may be filled with lubricating fluid so as to generate fluid dynamic pressure during rotation of the shaft 130.

A fluid dynamic pressure groove (not shown) for generating fluid dynamic pressure by pumping lubricating fluid during the rotation of the shaft 130 may be formed in at least one of the outer circumferential surface of the shaft 130 and the inner circumferential surface of the sleeve 120.

That is, fluid dynamic pressure for supporting the shaft 130 may be generated by the dynamic pressure groove during the rotation of the shaft 130, and accordingly, the shaft 130 may further stably rotate.

In addition, a bearing clearance may also be formed by the sleeve 120 and the cover member 102. The bearing clearance formed by the sleeve 120 and the cover member 102 may also be filled with lubricating fluid.

When the shaft 130 is installed in the sleeve 120, a lower surface of the shaft 130 contacts an upper surface of the cover member 102. Then, when the shaft 130 rotates, lubricating fluid is introduced between the sleeve 120 and the cover member 102 such that the shaft 130 may float by as much as a predetermined height.

A thrust plate 103 may be formed on an upper end portion of the shaft 130. In addition, the thrust plate 103 may be fixedly installed on the shaft 130 so as to face an upper surface of the sleeve 120.

Thus, while the shaft 130 rotates, the thrust plate 103 may rotate in connection with the shaft 130. In other words, the thrust plate 103 and the shaft 130 are rotation members constituting the rotor 40.

A cap member 104 may be disposed on the thrust plate 103 so as to face the thrust plate 103. In addition, the cap member 104 may be installed on the sleeve 120. In other words, the cap member 104 installed on the sleeve 120 is a fixed member constituting the stator 20.

An interface between lubricating fluid and air may be formed by a lower surface of the cap member 104 and an upper surface of the thrust plate 103. To this end, an inclination surface may be formed on an end portion of the lower surface of the cap member 104.

That is, the lubricating fluid filling the bearing clearance forms the interface with air in a space formed by the lower surface of the cap member 104 and the upper surface of the thrust plate 103 by a capillary action.

The rotor hub 140 rotates by being fixedly installed on the shaft 130 rotatably supported by the sleeve 120. That is, the rotor hub 140 is a rotation member that rotates in connection with the shaft 130 and is included in the rotor 40. The rotor hub 140 may be fixedly installed on the shaft 130 so as to be disposed above the thrust plate 103.

The rotor hub 140 may include a disk-shaped rotor hub body 142 having an installation hole 142a through which the shaft 130 passes, a magnet mounting portion 144 extending in the axial direction downwardly from an edge of the rotor hub body 142, and a disk seating portion 146 extending in the radial direction outwardly from an end of the magnet mounting portion 144.

That is, the rotor hub 140 may have an inverted cup shape. In addition, the rotor hub 140 and the base member 110 form an internal space. The stator core 101 may be disposed in the internal space formed by the rotor hub 140 and the base member 110.

In addition, a driving magnet 144a may be fixedly mounted on the magnet mounting portion 144. That is, the driving magnet 144a is fixedly installed on an inner circumferential surface of the magnet mounting portion 144 so as to face a front end of the stator core 101.

The driving magnet 144a may have a circular ring shape and may be a permanent magnet in which N and S poles are alternately magnetized in the circumferential direction to generate magnetic force having a predetermined magnitude. That is, the driving magnet 144a generates driving force allowing the rotor hub 140 to rotate.

In other words, when power is supplied to a coil 102 wound around the stator core 101, driving force allowing the rotor hub 140 to rotate is generated by electromagnetic interaction between the driving magnet 144a and the stator core 101 around which the coil 102 is wound. Thus, the rotor hub 140 is rotated.

Thus, due to the rotation of the rotor hub 140, the shaft 130 and the thrust plate 103 fixedly installed on the shaft 130 may also rotate together with the rotor hub 140.

When the rotor hub 140 rotates, the lubricating fluid filling the bearing clearance is pumped by the fluid dynamic pressure groove (not shown). Thus, fluid dynamic pressure is generated to rotatably support the shaft 130, and accordingly, the rotor 40 floats by as much as a predetermined height.

The pulling plate 150 is installed on the base member 110 so as to be disposed below the driving magnet 144a. That is, the pulling plate 150 is inserted into the installation groove 114 of the base member 110 and is disposed below the driving magnet 144a.

The pulling plate 150 may be fixedly installed on the base member 110 via an adhesive P.

As shown in FIGS. 2 and 3, the pulling plate 150 may include a body 152 having a circular ring shape, protrusion portions 154 protruding from the body 152, and indent portions 156 formed inwardly from an outer circumferential surface of the body 152.

The body 152 may have the circular ring shape so as to correspond to the shape of the driving magnet 144a.

In addition, the protrusion portions 154 may have a circular hemispherical shape contacting the side wall 115 of the installation groove 114 formed in the base member 110. That is, when the pulling plate 150 is inserted into the installation groove 114, the protrusion portions 154 may contact the side wall 115 so as to prevent deviation of the pulling plate 150.

The plurality of protrusion portions 154 may be spaced apart from each other in the circumferential direction. That is, the protrusion portions 154 prevent the position of a center of the body 152 from deviating from the position of a center of the driving magnet 144a, that is, the center of the installation hole 112a.

Thus, the center of the body 152 may not be deviated from the center of the driving magnet 144a due to the protrusion portions 154.

Accordingly, the generation of oscillations may be prevented. Simultaneously, when the pulling plate 150 is fixedly installed on the base member 110 using the adhesive P, the adhesive P may uniformly contact a lower surface of the body 152, thereby increasing the degree of adhesion.

In addition, the plurality of protrusion portions 154 may be spaced apart from each other in the circumferential direction. For example, the plurality of protrusion portions 154 may be spaced apart from each other while having a central angle of 120 degrees.

According to the present embodiment, three protrusion portions 154 are provided and each central angle of the protrusion portions 154 is 120 degrees. However, the present invention is not limited thereto.

That is, the number of protrusion portions 154 and each central angle of the plurality of protrusion portions 154 may be changed in various ways.

The plurality of indent portions 156 may be provided and may be arranged in the circumferential direction between the protrusion portions 154.

In addition, the adhesive P for adhering the pulling plate 150 to the base member 110 may be introduced into the indent portions 156, thereby increasing the degree of adhesion between the pulling plate 150 and the base member 110.

That is, the indent portions 156 may increase a contact area between the adhesive P and the pulling plate 150 to prevent the deviation of the pulling plate 150.

According to the present embodiment, three indent portions 156 are provided. However, the present invention is not limited thereto.

As described above, when the pulling plate 150 is installed via the protrusion portions 154, the deviation of the pulling plate 150 may be prevented. Thus, the adhesive P may uniformly contact the lower surface of the pulling plate 150, thereby preventing the degree of adhesion from being changed according to positions.

In addition, the contact area between the adhesive P and the pulling plate 150 may be increased via the indent portions 156, thereby increasing the degree of adhesion between the pulling plate 150 and the base member 110.

As set forth above, according to embodiments of the present invention, when a pulling plate is installed via protrusion portions, deviation of the pulling plate may be prevented, and the degree of adhesion between the pulling plate and a base member may be increased via an adhesive filled in indent portions.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a rotor hub having a driving magnet mounted on an internal surface thereof; and
a pulling plate fixedly installed on a base member to be disposed below the driving magnet,
wherein the pulling plate includes a body having a ring shape, protrusion portions protruded from the body, and an indent portion formed inwardly from an outer circumferential surface of the body.

2. The spindle motor of claim 1, wherein the pulling plate is inserted into an installation groove formed downwardly from an upper surface of the base member, and
the protrusion portions having a circular hemispherical shape contact a side wall of the installation groove formed in the base member.

3. The spindle motor of claim 1, wherein the protrusion portions include at least three or more protrusion portions to prevent a position of a center of the body from deviating from a position of a center of the driving magnet during installation.

4. The spindle motor of claim 3, wherein the indent portion includes a plurality of indent portions arranged in a circumferential direction between the protrusion portions.

5. The spindle motor of claim 1, wherein the pulling plate is fixedly installed on the base member using an adhesive, and
the adhesive is provided in the indent portion.
